(19) United States
(12) Patent Application Publication
(10) Pub. No.: US 2014/0222565 A1
(43) Pub. Date: Aug. 7, 2014

(54) SYSTEM AND METHOD OF SELLING PRODUCTS

(71) Applicant: Aaron Dormer, East Lindfield (AU)

(72) Inventor: Aaron Dormer, East Lindfield (AU)

(73) Assignee: The Digital Incubator Pty Ltd., Hornsby ,New South Wales (AU)

(21) Appl. No.: 14/235,767

(22) PCT Filed: May 31, 2012
(86) PCT No.: PCT/AU2012/000616

§ 371 Date: Apr. 4, 2014

(30) Foreign Application Priority Data
Jul. 29, 2011 (AU) 2011903024

(51) Int. Cl. G06Q 30/02

(52) U.S. Cl. CPC G06Q 30/0255
USPC 705/14.53

(57) ABSTRACT

A system and method of selling products is described, the method including the steps of: offering products for sale in a retail store; a person visiting the retail store; a person browsing the stock offered for sale; a person scanning the barcode on a product of interest to obtain additional product details; receiving indication information in an electronic form which identifies a person and at least one product that they are interested in purchasing; processing the indication information to determine a revised offer of sale; transmitting the revised offer of sale in an electronic form to the person.

### TECHNICAL FIELD

The present invention relates to systems and methods of selling products.

### BACKGROUND TO THE INVENTION

By visiting a retail store, customers can browse through goods marked with prices and may elect to purchase goods by taking them to a cash register in the store.

In recent times there has been an increasing trend for consumers to make on-line purchases of products which are later delivered to them. Online retailers typically make details of their products available for viewing via a website such as one or more images along with a description of the product. Due to the fact that online retailers do not incur the expense of renting and maintaining a retail store, their overhead costs are lower, and they can often offer the same products that are offered by retail stores at more competitive prices than can be offered by traditional retail stores.

Operators of retail stores have noticed a growing trend that consumers will visit their store to browse and inspect products, and make price comparisons. However, rather than make a purchase in store, the consumer will leave the store and search online in an attempt to locate the same or similar products being offered for sale by an online retailer. Often, consumers will find that they can purchase the same or similar products on-line at a price that is less than was being asked in the retail store and will thus decide to purchase from the online retailer, rather than from the store where they browsed and inspected products

### SUMMARY OF THE INVENTION

In a first aspect the present invention provides a method of selling products including the steps of: offering products for sale in a retail store; receiving indication information in an electronic form which identifies a person and at least one product that they are interested in purchasing; processing the indication information to determine a revised offer of sale; transmitting the revised offer of sale in an electronic form to the person.

The step of processing the indication information may be based on information relating to the product.

The information relating to the product may include stock levels, volume of sales made over a timeframe or product life cycle information.

The step of processing the indication information may be based on information relating to the person.

The information relating to the person may include prior purchasing information or social influence information relating to the person.

The method may further include the step of delaying the transmission of the revised offer of sale by a pre-determined time interval.

In a second aspect the present invention provides a system for selling products via a retail store including: receiving means for receiving indication information in an electronic form which identifies a person and at least one product that they are interested in purchasing; processing means for processing the indication information to determine a revised offer of sale; transmitting means for transmitting the revised offer of sale in an electronic form to the person.

The indication information may include information relating to the product.

The information relating to the product may include stock levels, volume of sales made over a timeframe or product life cycle information.

The indication information may include information relating to the person.

The information relating to the person may include prior purchasing information or social influence information relating to the person.

The system may be arranged to delay transmission of the revised offer of sale by a pre-determined time interval.

Traditionally, the retailers influence on the purchasing decision ends when the customer leaves the retail shopfront. Embodiments of the invention provide retailers with a digital medium via mobile applications i.e. email, mobile applications and/or website to extend the reach of the purchasing influence after prospective browsers have left the retail shopfront.

### BRIEF DESCRIPTION OF THE DRAWINGS

An embodiment of the present invention will now be described, by way of example only, with reference to the accompanying drawings, in which:

FIG. 1 is a schematic view of a system for selling products according to an embodiment of the invention;

FIG. 2 is a flow chart showing significant steps in a method carried out by way of the system of FIG. 1;

FIG. 3 illustrates a login screen presented to a customer by the system of FIG. 1;

FIG. 4 illustrates the screen view seen by a customer when scanning a barcode of a product using the camera function on their mobile phone;

FIG. 5 is a screen view shown to a customer after scanning the barcode of FIG. 4;

FIG. 6 shows an example of a retailer's dashboard presented to a retailer by the system of FIG. 1;

FIG. 7 shows a screen view of the dashboard of FIG. 6.

### DETAILED DESCRIPTION OF THE PREFERRED EMBODIMENT

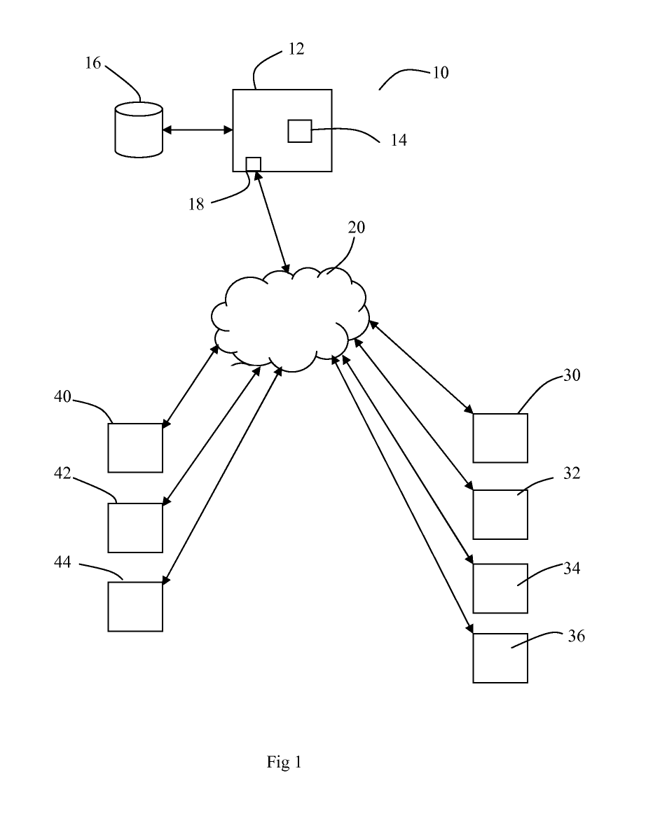

Referring to FIG. 1, a commerce system 10 is shown for selling products via retail stores 30, 32, 34, 36. The system is conducted by way of an Internet connected server computer 12 running suitably configured software under control of an operating system by way of a typical processor and memory architecture 14. Server 12 is connected to database 16 used for storing and retrieving information used in operating the system. Server 12 communicates via the internet 20 by way of router 18 to receive and transmit information used in the system as will be later described.

System 10 may be thought of as a commerce platform which facilitates sale of products in any number of retail stores 30, 32, 34, 36 to customers 40, 42, 44.

Retailers 30, 32, 34 & 36 participate in the system by providing details of their retail stock for inclusion in database 16. The details of the stock provided include:

product code, product name, product details (such as style, size colour), product description, one or more images of the product, the product's Recommended Retail Price (RRP) and product availability.

The server 12 is configured with a number of revised offers for sale that may be made to customers as will be later described. In its simplest form, the revised offer is an offer for sale of a product at a reduced price. In another form, it could be an offer to purchase a number of the same items at a bulk discount, or could take the form of offering the product bundled with one or more additional products or a partner offer such as a voucher which could be redeemed with another retailer.

Customers 40, 42, 44 carry mobile computing devices in the form of internet enabled smart phones. The customer's phones have been configured to operate with system 10 by previously downloading and installing proprietary application software. The phones include cameras and the application software includes a barcode reading routine which is configured to monitor the output of the phone camera to detect the presence of a barcode in the field of view of the camera.

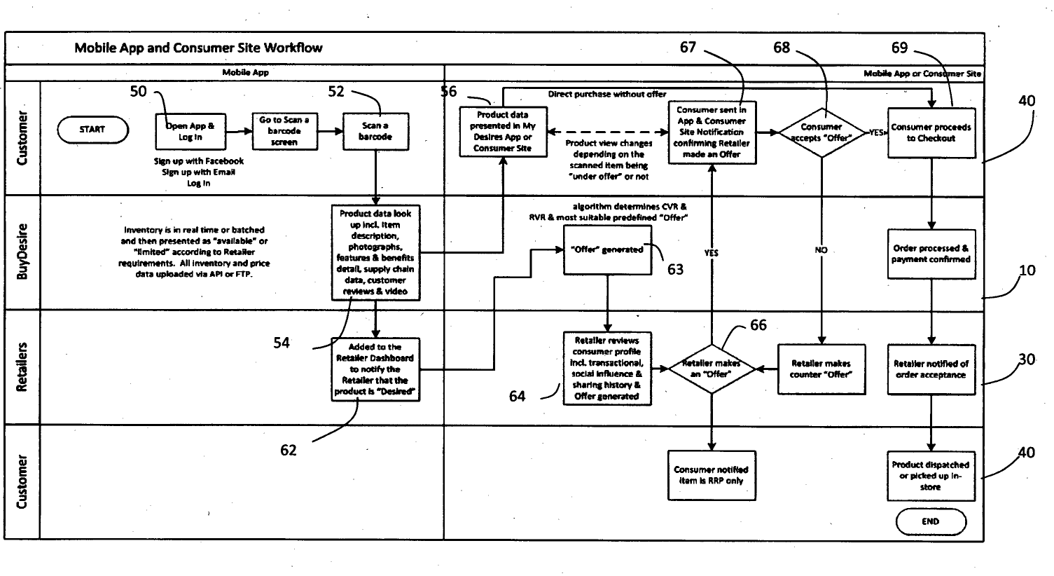

Operation of system 10 will now be described with reference to the flowchart of FIG. 2. In the flowchart, method steps carried out by customers are shown in regions 40, those carried out by retailers are shown in region 30 and those carried out by system 10 or the operator of the system are shown in region 10.

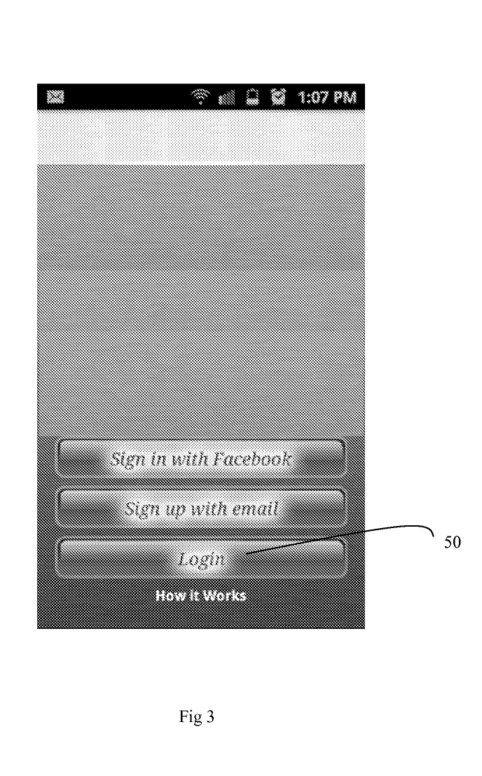

Customer 40 visits retail store 30 and browses the stock which is being offered for sale in the store at a first price, being the recommended retail price (RRP) in the usual manner. If customer 40 is interested in a product then they may elect to scan the product barcode to obtain additional product details. Customer 40 opens the application installed on their phone and logs 50 into the system (see FIG. 3) or registers with the system if using for the first time.

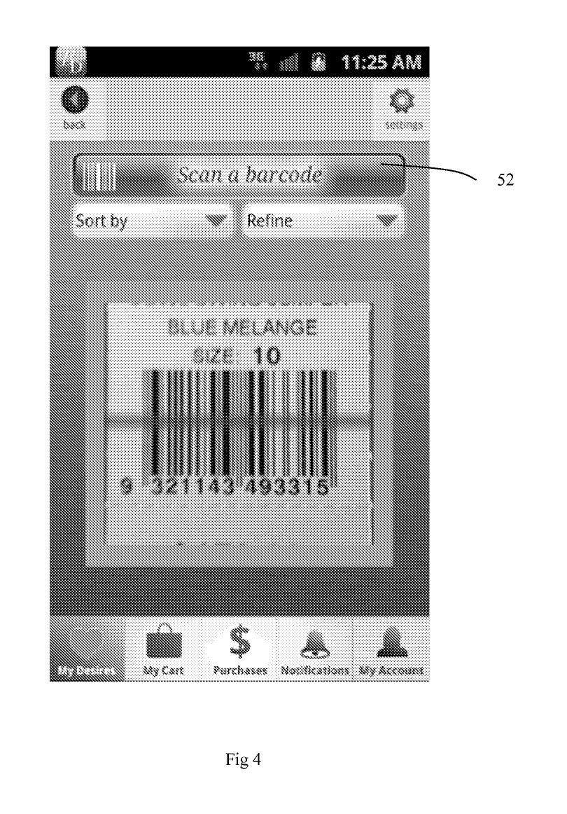

Referring to FIG. 4, customer selects the option to “Scan a barcode” 52 which activates their phone camera and barcode reading routine. When a barcode is detected in the field of view of the phone camera, the barcode is captured and decoded to obtain a unique product code.

The customer's phone then transmits indication information via internet 20 to be received at server 12. The indication information includes data identifying the customer in the form of their username. The indication information also includes information identifying the product they are interested in the form of the product code that was obtained by scanning the barcode.

Server 12 looks up information in database 16 relating to the product such as the name of the product, specifications of the product, an image or video of the product, a description of the product, customer reviews of the product and the RRP price of the product. At step 56 the information regarding the product is displayed to the customer by way of an acknowledgement that their interest in the product has been registered by the system.

At step 62 the interest registered by the customer is presented in the retailer's dashboard (described below). At step 63 server 12 applies an algorithm to determine a revised offer of sale of the product to the person. The algorithm calculates two ratings which form the basis for determining a revised offer of sale. The first is based on the retailer and product attributes (hereinafter referred to as the Retailer Value Rating or RVR) including but not limited to the product life cycle, stock levels, volume of sales made over a timeframe (retailer outlet specific), recommended retail price, product size etc. The higher the RVR the more a retailer wants to sell the product and the more aggressively they are prepared to be to make a better offer of sale to the person.

Importantly for clothing or footwear applications, the barcode information not only identifies a particular style of an item of clothing or footwear, but also identifies the colour and size of the item. Therefore, the RVR may differ for different sizes of the same item of clothing if, for instance, the retailer had more stock of a particular size than another, and so was more eager to sell the items of sizes with the greater amount of remaining stock.

The second is based on the customer (hereinafter referred to as Customer Value Rating or CVR) and includes, but is not limited to, variables such as the person's social value, their loyalty to the operator of the system or the retailer, customer life cycle (are they a new or loyal customer), their propensity to purchase in app. The more appealing a customer is the higher their CVR will be and the better the offer the retailer is willing to make.

The customer can select preferences to share details of their activity with other customers. For example, a customer can scan a barcode and in the process of doing that, shares the product details with their contacts in a social network. This brand sharing process is encapsulated within the customer's profile in the platform assuming the customers profile it is linked to profiles on other social platforms.

A higher CVR value is assigned to customers who have previously purchased products from them to encourage customer loyalty. Also, a higher CVR value is assigned to a customer who has made numerous brand shares because of their level of social influence amongst their friends, acquaintances and community.

A higher CVR value is assigned to a customer who has a high measure of social influence in the hope that that customer shares a positive impression of the retailer within their circle of influence. Social influence may be inferred from the number of social contacts such as social network connections that a customer has. Similarly, a measure of social influence can be additionally be inferred from the volume of messages or notifications that they post or send to their online social contacts such as number of tweets, Facebook posts, or emails.

Once a product barcode has been scanned, a CVR is calculated for the person and an RVR is calculated for the particular product of the particular retailer both on a scale of 1 to 5 stars. The algorithm then takes the higher of these two ratings and looks up pre-configured offers for sale which have been pre-configured to correspond with certain minimum ratings values to determine which offer should be made to the person.

The offer is associated with a pre-configured time delay. The offer is not transmitted back to the person until the time period has elapsed. The time period is configurable and may be as short as 5 minutes or could be a number of days or even weeks.

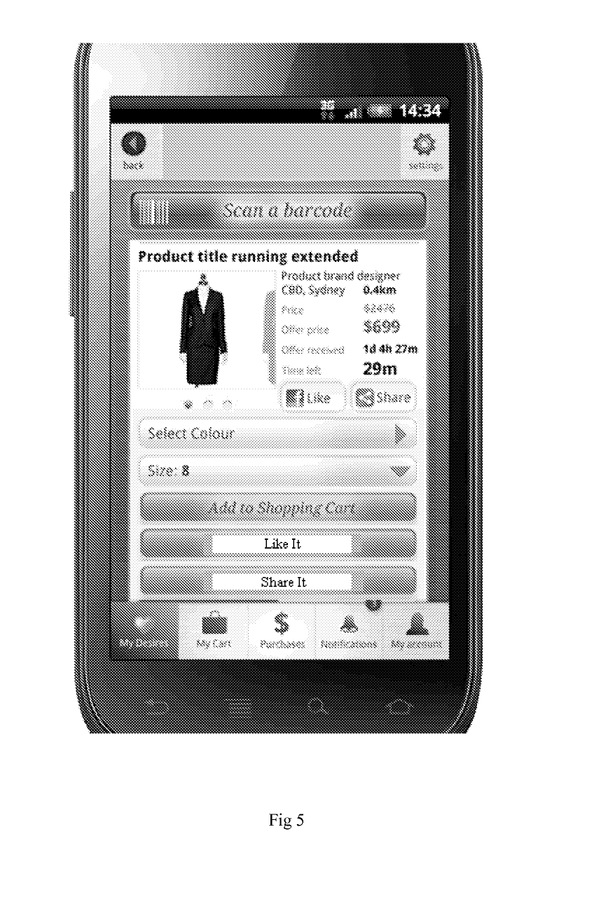

Referring again to FIG. 2, at step 66 the details of the revised offer for sale are transmitted to the customer's phone to be presented on screen to the customer 40 (see FIG. 5). In the example of FIG. 5, a customer is offered a suit with an RRP of $2476 at a reduced price of $699.

Customer decides whether or not to accept the revised offer 68. If the customer decides to accept the offer then the customer is directed to an online checkout screen 69 which the customer completes in a known manner. As part of the checkout procedure the customer may elect to have the product delivered to them, or whether they would prefer to collect the item from the retail store.

Revised offers typically have an expiry time of between 4 to 48 hrs. If an offer is not accepted by this time then it expires.

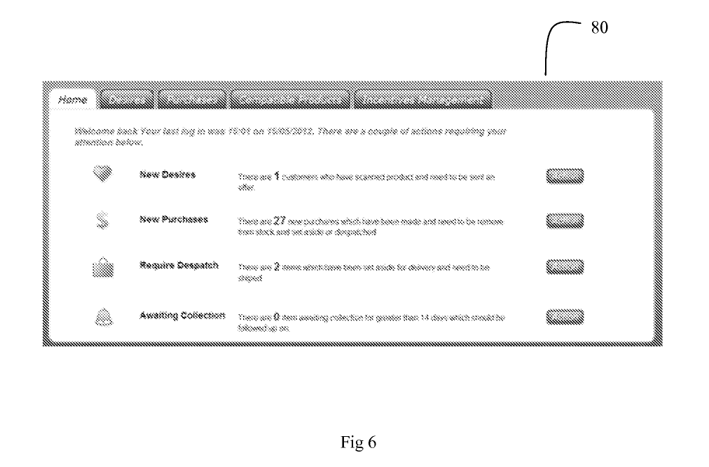

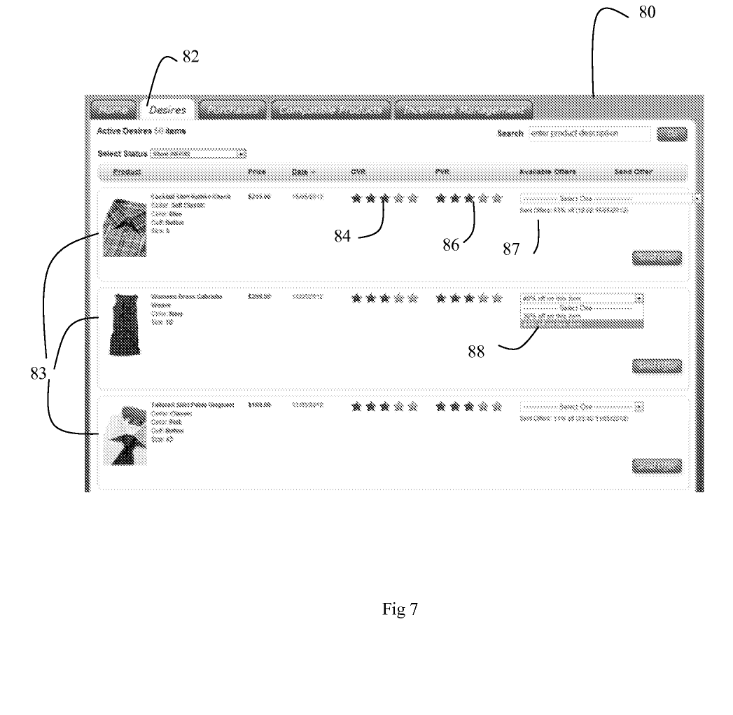

Server 12 is configured to present a user interface accessible by retailers 30, 32, 34, 36 known as the retailer's dashboard 80 (see FIG. 6). When a customer indicates their interest in a product, this causes an entry to appear in the “desires” tab 82 (see FIG. 7) of retailer's dashboard 80. The dashboard 80 provides a summary view of indications 83 from various customers that they want particular products. Each indication 83 includes details of the product along with the calculated CVR 84 and RVR 86 ratings. The revised offer 87 calculated by the system is shown along with details of when the offer was sent, or is scheduled to be sent. A retailer can choose to overwrite the default offer and select from one of the other most suitable offers 88 according to the algorithm to present to the person, if they choose to do so.

System 10 is a commerce platform that can be configured to be utilised by a range of different retailers under a range of different brands. Screen views presented to customers can be branded with particular retailers get up and trademarks.

In the embodiment described above, the customers interacted with system 10 by way of internet enabled smart phones. Similarly, customers could use alternative computing devices such as laptop, handheld or tablet type computing devices.

To provide for backwards compatibility for customers who do not carry a suitable mobile computing device, a kiosk or scanning station with a touch screen or the like may be provided in store for the use of customers to look up products and make indications that they want particular products.

In the embodiment described above the customers scanned products by way of scanning a barcode using the camera function of their mobile phone. Similarly, products may be identified in other ways such as by scanning RFID of NFC tags attached to products, or by scanning the barcode with a dedicated bar code scanner.

The product may be identified by image recognition from a picture taken by the customer. The code identifying the product could be typed in by the customer.

In the embodiment described above the customers communicated with server 12 over the internet. Similarly, customers can communicate using other methods such as by way of SMS or email messages.

It can be seen that embodiments of the invention have at least one of the following advantages:
Customers are made personalised offers on products that they want thus maintaining a dialogue with the customer after they have left the retail store to encourage the customer to purchase from the retail store, rather than seeking the same product at a reduced price from an alternative online retailer.
Retailers can use their in-house knowledge of their product lines such as popularity, remaining volume of stock in particular sizes or colours, to accurately calculate revised sale offers to optimise their return on the sales of their goods.
Customers are rewarded for brand loyalty, and for being engaged or supportive of a brand, thus building goodwill towards the brand.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A method of selling products including the steps of:
offering products for sale in a retail store;
receiving indication information in an electronic form which identifies a person and at least one product that they are interested in purchasing;
processing the indication information to determine a revised offer of sale;
transmitting the revised offer of sale in an electronic form to the person.

2. A method according to claim 1 wherein the step of processing the indication information is based on information relating to the product.

3. A method according to claim 2 wherein the information relating to the product includes stock levels, volume of sales made over a timeframe or product life cycle information.

4. A method according to any preceding claim wherein the step of processing the indication information is based on information relating to the person.

5. A method according to claim 4 wherein the information relating to the person includes prior purchasing information or social influence information relating to the person.

6. A method according to any preceding claim further including the step of delaying the transmission of the revised offer of sale by a pre-determined time interval.

7. A system for selling products via a retail store including:
receiving means for receiving indication information in an electronic form which identifies a person and at least one product that they are interested in purchasing;
processing means for processing the indication information to determine a revised offer of sale;
transmitting means for transmitting the revised offer of sale in an electronic form to the person.

8. A system according to claim 7 wherein the indication information includes information relating to the product.

9. A system according to claim 8 wherein the information relating to the product includes stock levels, volume of sales made over a timeframe or product life cycle information.

10. A system according to any one of claims 7 to 9 wherein the indication information includes information relating to the person.

11. A system according to claim 10 wherein the information relating to the person includes prior purchasing information or social influence information relating to the person.

12. A system according to any one of claims 7 to 11 which is arranged to delay transmission of the revised offer of sale by a pre-determined time interval.
